(19) United States
(12) Patent Application Publication
(10) Pub. No.: US 2011/0259864 A1
(43) Pub. Date: Oct. 27, 2011

(54) Digital Auto Hot Towel Cabinet Systems

(76) Inventor: Rene Galietti, Floral Park, NY (US)

(21) Appl. No.: 13/090,636

(22) Filed: Apr. 20, 2011

Related U.S. Application Data
(60) Provisional application No. 61/326,488, filed on Apr. 21, 2010.

(51) Int. Cl. H05B 1/00

(52) U.S. Cl. 219/201

(57) ABSTRACT

A hot towel cabinet comprising a frame; a door; at least one removable rack; a timer; a UV light lamp; and a heating unit. The frame defines an outer parameter of the inner volume and the door is hingedly coupled to the frame such that the inner volume is accessible by a user. The removable rack is suitable to hold at least one towel during at least one sanitizing and warming period and the timer is settable to initiate and time the sanitizing and warming period. The UV light lamp sanitizes the towels during the sanitizing and warming period and the heating unit operates to provide heat to the inner volume. The hot towel cabinet is usable to contain the towels during the sanitizing and warming period such that the towels are sanitized and warmed up for a warm towel treatment and/or service.

### CROSS-REFERENCE TO RELATED APPLICATION

The present application is related to and claims priority from prior provisional application Ser. No. 61/326,488, filed Apr. 21, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of towel warmers and more specifically relates to a digital towel warmer and sanitizer.

### 2. DESCRIPTION OF THE RELATED ART

Rest and relaxation are sometimes impossible to attain by many Americans trying to balance the demands of family and career. This balancing act could account for the continued growth in interest in services performed by spas, medical spas and therapy centers. More and more people enjoy spa services and experience them on a regular basis. Therefore, specialist institutes, spas, therapy centers, chiropractic offices, and other similar businesses are all offering a wide range of relaxing and restorative spa and therapy options, each with their own signature, range of treatments, and ambience.

Some spas and therapy centers utilize warm towels as part of their array of services and treatments. Traditionally, to bring the towels to optimal temperatures, staff members must arrive at work prior to their first appointments. This time-consuming preparation process is inconvenient and requires staff members to rearrange their personal schedules. If the process is not properly executed, towels may end up too hot or too cold, interfering with the intended treatments. Further, towels which are used in spas and medical therapy centers may be contaminated with viruses or bacteria because they are used by a large number of people. Since the towel usually contacts the body it may be a dangerous transmitter of bacteria which may be harmful to the user.

Therefore a need exists for a device which may warm up towels to a desired temperature and which at the same time sanitizes towels to ensure proper hygiene to prevent the spread of germs and bacteria. A need exists for a towel warmer and sanitizer which is designed to operate on a programmable schedule, effectively ensuring optimal towel temperatures whenever necessary so as to provide more convenience to staff members of spas and therapy centers.

Various attempts have been made to solve the above-mentioned problems such as those found in U.S. Pat. Nos. and U.S. Pub. Nos. 6,693,260, 7,279,659, 5,842,287, 6,982,399, 2006/0191901, and 6,384,380. This prior art is representative of towel warmers. None of the above inventions and patents, taken either singly or in combination, is seen to describe the invention as claimed.

Ideally, a towel warmer and sanitizer should require little maintenance, be easy to use, would operate reliably and be manufactured at a modest expense. Thus, a need exists for a reliable towel warmer and sanitizer to warm up and sanitize towels simultaneously and to avoid the above-mentioned problems.

### BRIEF SUMMARY OF THE INVENTION

In view of the foregoing disadvantages inherent in the known towel warmer art, the present invention provides a novel towel warmer and sanitizer system. The general purpose of the present invention, which will be described subsequently in greater detail, is to provide a towel warmer and sanitizer which is designed to operate on a timed schedule, effectively ensuring optimal towel temperatures whenever necessary.

Disclosed is a hot towel cabinet comprising a frame having an inner volume, a top wall, a bottom wall, a rear wall, a right wall, a left wall, a front wall planar mount, and a front face; a door; at least one removable rack; a timer; a UV light lamp; and a heating unit.

The frame defines an outer parameter of the inner volume and the door is hingedly coupled to the frame such that the inner volume is accessible by a user. The removable rack is suitable to hold at least one towel during at least one sanitizing and warming period and the timer is settable to initiate and time the sanitizing and warming period. The UV light lamp sanitizes the towels during the sanitizing and warming period and the heating unit operates to provide heat to the inner volume. The hot towel cabinet is usable to contain the towels during the sanitizing and warming period such that the towels are sanitized and warmed up for a warm towel treatment and/or service.

A preferred method of use is further disclosed herein comprising the following steps: placing at least one towel in a hot towel cabinet; programming the hot towel cabinet via a user interface to start and stop warming up and sanitizing of at least one towel at a desired time; warming up and sanitizing at least one towel; removing at least one warmed up and sanitized towel from the towel cabinet.

The present invention holds significant improvements and serves as a Digital Auto Hot Towel Cabinet System. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Digital Auto Hot Towel Cabinet Systems, constructed and operative according to the teachings of the present invention.

FIG. 1 shows a perspective view illustrating a hot towel cabinet in an in-use condition according to an embodiment of the present invention.

FIG. 2 is a perspective view illustrating the hot towel cabinet according to an embodiment of the present invention of FIG. 1.

FIG. 3 is a perspective view illustrating the hot towel cabinet according to an embodiment of the present invention of FIGS. 1 and 2.

FIG. 4 is a perspective view illustrating the hot towel cabinet according to an embodiment of the present invention of FIGS. 1-3.

FIG. 5 is a flowchart illustrating a method of using a hot towel cabinet according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a towel warming device and more particularly to a digital towel warmer and sanitizer as used to warm up and sanitize towels which is designed to operate on a timed schedule.

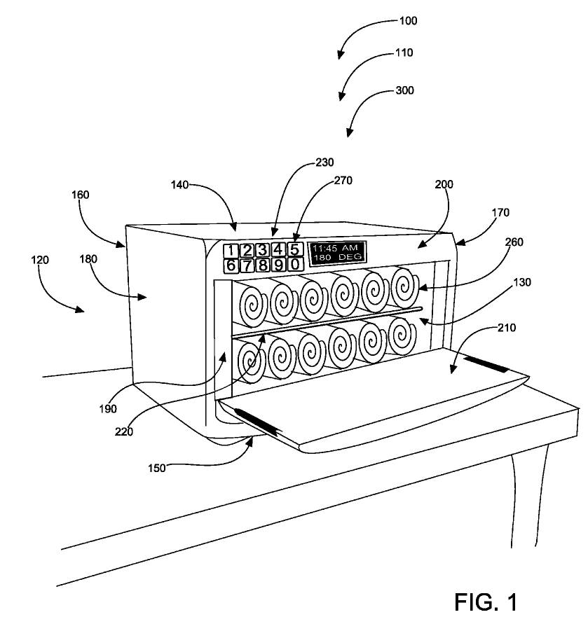

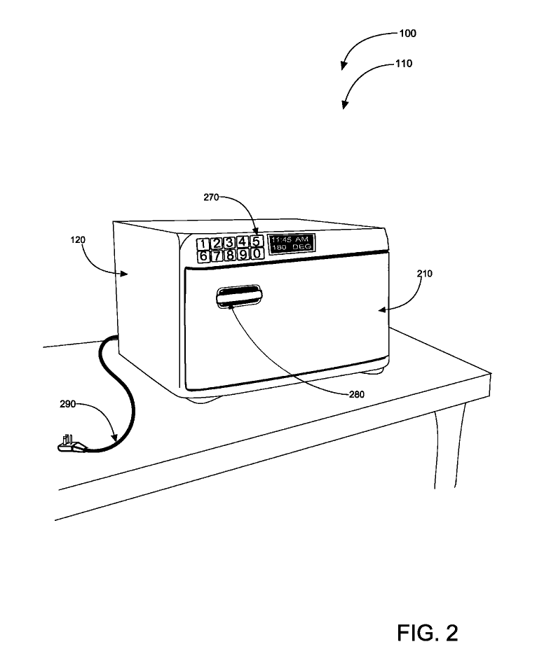

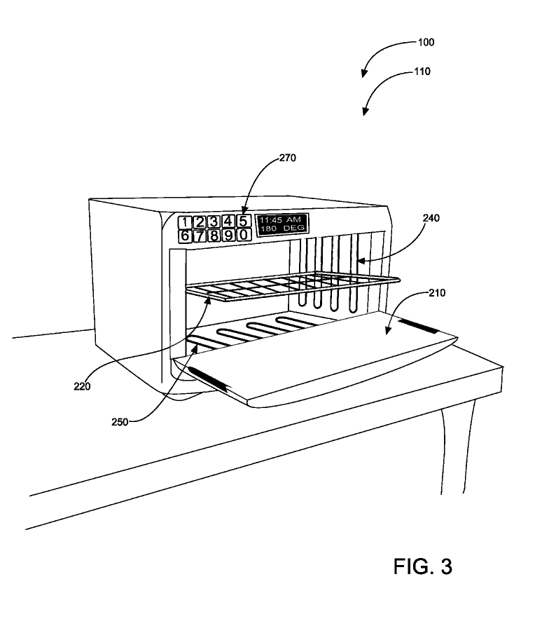

Referring to the drawings by numerals of reference there is shown in FIG. 1, a perspective view illustrating hot towel cabinet 110 in an in-use condition 300 according to an embodiment of the present invention, and FIGS. 2 and 3, perspective views illustrating hot towel cabinet 110 according to an embodiment of the present invention of FIG. 1.

Hot towel cabinet 110 preferably comprises frame 120, inner volume 130, top wall 140, bottom wall 150, rear wall 160, right wall 170, left wall 180, front wall planar mount 190, and front face 200.

Top wall 140, bottom wall 150, rear wall 160, right wall 170, left wall 180, and front wall planar mount 190 define frame 120 and inner volume 130. Frame 120 preferably measures 14 inches in height, 20 inches in length, and 12 inches in width and inner volume 130 thereby may be large enough to house 20-30 towels at once. However, it should be appreciated that other heights, lengths, and widths will fall within the scope and spirit of the invention as described herein, and that any references to sizes, heights, etc are exemplary, and are not to be construed as limiting in any way.

Frame 120 is preferably made of heat resistant material such as aluminum or ceramic and defines an outer parameter of inner volume 130. Frame 120 may be made available in white, silver or other suitable colors. Inner volume 130 may preferably comprise an envelope comprising corrosion resistant aluminum or any other corrosion resistant material such as stainless steel.

Right wall 170 and left wall 180 preferably comprise rack tabs which are installed on the inside of hot towel cabinet 110. At least one removable rack 220 preferably comprising a grate may be attached to right wall 170 and left wall 180 via rack tabs. Removable rack 220 is suitable to hold at least one towel 260 during at least one sanitizing and warming period. Removable rack 220 may preferably be made of aluminum, stainless steel or plastic. A drip catch to catch excess moisture may be removably attached to right wall 170 and left wall 180 underneath removable rack 220. The drip catch may be designed so that it is easily accessible and may be easily emptied by user and is preferably made of corrosion resistant material. Towel 260 may be rolled up and placed on removable rack 220. Alternatively, hot towel cabinet 110 may comprise a multitude of sturdy bars over which a multitude of towels 260 may be draped. Towels 260 may be placed in hot towel cabinet 110 to create in-use condition 300, as shown in FIG. 1.

Hot towel cabinet 110 further comprises heating unit 250. Electrical power is transferred to heating unit 250 through power cord 290. Heating unit 250 is integral with hot towel cabinet 110 and operates to provide heat to inner volume 130. Heating unit 250 may comprise an air circulation device or fan and an electrical heating element to heat the air discharged by the circulation device or fan. However, heating unit 250 may comprise any suitable heating mechanism, such as a heater/fan combination, hot water, oil heat, contact type heaters or radiant heat arrangements. Heating unit 250 preferably is connected to a control unit comprising a thermostat and a sensor and to timer 230 which may start and terminate the warming of inner volume 130 after a predetermined event.

Timer 230 preferably is settable to initiate and end the sanitizing and warming period and hot towel cabinet 110 preferably may be programmed to turn on at a specific time, to turn off at a certain threshold temperature or to turn off at a certain threshold time. Timer is connected to control unit which preferably comprises a sensor which functions to sense a predetermined threshold temperature. User therefore may program hot towel cabinet 110 via user interface 270 to operate on a timed schedule. Hot towel cabinet 110 may further comprise an automatic shut off in the event of overheating of heating unit 250. The automatic shut off may automatically turn hot towel cabinet 110 off when a predetermined temperature or time limit is reached so as to prevent fire hazards. However, any type of heating and temperature control system may be used for hot towel cabinet 110.

Hot towel cabinet 110 further includes UV light lamps 240 which may be used to sanitize towels 260. UV light is germicidal—i.e., it deactivates the DNA of bacteria, viruses and other pathogens and thus terminates their ability to multiply and cause disease. Ultraviolet technology is a non-chemical approach to disinfection. In this method of disinfection, nothing is added which makes this process simple, inexpensive and requires very low maintenance. UV light lamps 240 preferably comprise germicidal UV-C light for deactivating and killing germs and thereby provide an effective means for sanitizing towels 260 placed into hot towel cabinet 110.

UV light lamps 240 may comprise bulbs in an elongated tubular configuration which may be installed along the inside of top wall 140, bottom wall 150, rear wall 160, right wall 170 and left wall 180 of hot towel cabinet 110. UV light lamps 240 sanitize rolled or draped towels 260 during the sanitizing and warming period and may be operated via user interface 270. Hot towel cabinet 110 is usable to contain towels 260 during the sanitizing and warming period such that towels 260 are sanitized and warmed up simultaneously.

Hot towel cabinet 110 further comprises user interface 270 which is connected to control unit for controlling the temperature and timer 230. User interface 270 may comprise regular control buttons or touch control buttons and a digital time and temperature indicator so as ease user's interaction with hot towel cabinet 110. User interface 270 preferably is situated on front face 200 of hot towel cabinet 110. Therefore, user may place towel 260 in hot towel cabinet 110, close door 210 of hot towel cabinet 110 and program hot towel cabinet 110 via user interface 270 to start and stop warming up and sanitizing of at least one towel 260 at a desired time or temperature. Hot towel cabinet 110 may warm up towels to a desired temperature and at the same time may sanitize towels to ensure proper hygiene and to prevent the spread of germs and bacteria. At the end of the warming and sanitizing period user may remove heated and sanitized towel 260 from hot towel cabinet 110.

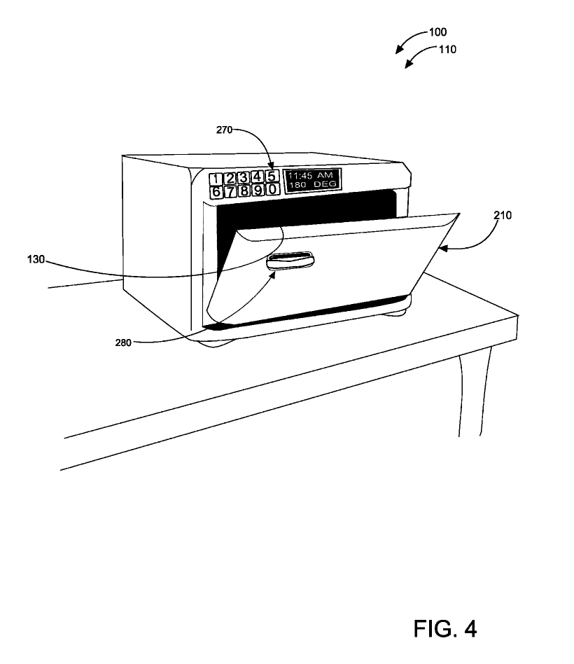

Referring now to FIG. 4 is a perspective view illustrating hot towel cabinet 110 according to an embodiment of the present invention of FIGS. 1-3.

Hot towel cabinet 110 further comprises door 210. Door 210 preferably comprises an insulated seal and a lockable handle 280. Door 210 defines a swingably rotatable front wall that is able to be removably attached to front wall planar mount 190 and which is able to be repeatedly moved between open and closed positions. Door 210 is hingedly coupled to frame 120 such that inner volume 130 is accessible by a user. Door 210 may preferably be made of aluminum, ceramic or plastic. However, door 210 may comprise any kind of suitable and durable heat-resistant material.

Digital Auto Hot Towel Cabinet Systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

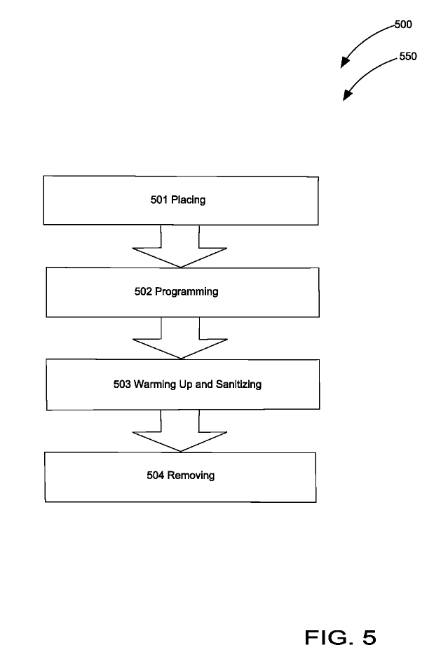

Referring now to FIG. 5, a flowchart 550 illustrating a method of using a hot towel cabinet 500 according to an embodiment of the present invention of FIGS. 1-4.

In accordance with the embodiments of the present invention a preferred method of use 500 is disclosed herein comprising: step one 501 placing at least one towel 260 in hot towel cabinet 110; step two 502 programming hot towel cabinet 110 via user interface 270 to start and stop warming up and sanitizing of at least one towel 260 at a desired time; step three 503 warming up and sanitizing at least one towel 260; step four 504 removing at least one warmed up and sanitized towel 260 from towel cabinet 110.

The time-consuming preparation process which requires users to rearrange their personal schedules is thereby eliminated since users may program hot towel cabinet 110 via user interface 270 to operate on a timed schedule, thereby effectively ensuring optimal towel temperatures whenever necessary.

It should be noted that the steps described in the method of use 500 can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A hot towel cabinet comprising:
a frame having an inner volume, a top wall, a bottom wall, a rear wall, a right wall, a left wall, a front wall planar mount, and a front face;
a door;
at least one removable rack;
a timer;
at least one UV light lamp; and
a heating unit;
wherein said frame defines an outer parameter of said inner volume;
wherein said door is hingedly coupled to said frame such that said inner volume is accessible by a user;
wherein said removable rack is suitable to hold at least one towel during at least one sanitizing and warming period;
wherein said timer is settable to initiate and time said sanitizing and warming period;
wherein said UV light lamp sanitizes said towels during said sanitizing and warming period;
wherein said heating unit is integral with said hot towel cabinet and operates to provide heat to said inner volume; and
wherein said hot towel cabinet is usable to contain said towels during said sanitizing and warming period such that said towels are sanitized and warmed up for a warm towel treatment and/or service.

2. The hot towel cabinet of claim 1 wherein said hot towel cabinet further comprises a control unit.

3. The hot towel cabinet of claim 1 wherein said hot towel cabinet can be programmed to turn on at a specific time.

4. The hot towel cabinet of claim 1 wherein said hot towel cabinet can be programmed to turn off at a certain threshold temperature.

5. The hot towel cabinet of claim 1 wherein said hot towel cabinet can be programmed to turn off at a certain threshold time.

6. The hot towel cabinet of claim 1 wherein said front face comprises a user interface for setting a temperature and time of said sanitizing and warming period.

7. The hot towel cabinet of claim 2 wherein said user interface is in communication with said timer and said control unit to control a duration and temperature of said sanitizing and warming period.

8. The hot towel cabinet of claim 1 wherein said door comprises an insulated seal.

9. The hot towel cabinet of claim 1 wherein said hot towel cabinet further comprises a drip tray to catch excess moisture.

10. The hot towel cabinet of claim 1 wherein an envelope of said inner volume of said frame comprises corrosion resistant aluminum.

11. The hot towel cabinet of claim 1 wherein said hot towel cabinet comprises an AC power cord.

12. The hot towel cabinet of claim 1 wherein said hot towel cabinet further comprises rack tabs for holding said rack.

13. The hot towel cabinet of claim 1 wherein said rack comprises a grate.

14. The hot towel cabinet of claim 1 wherein said door comprises a swingably rotatable front wall that is able to be removably attached to said front wall planar mount.

15. The hot towel cabinet of claim 1 wherein said door is able to be repeatedly moved between open and closed positions, said open position allowing said user to access said towel.

16. The hot towel cabinet of claim 1 wherein said door comprises a lockable handle.

17. The hot towel cabinet of claim 1 wherein said user interface comprises a digital time and temperature indicator.

18. A hot towel cabinet comprising:
a frame having an inner volume comprising an envelope comprising corrosion resistant aluminum, a top wall, a bottom wall, a rear wall, a right wall, a left wall, a front wall planar mount, and a front face;
a door comprising an insulated seal, a lockable handle, a swingably rotatable front wall that is able to be removably attached to said front wall planar mount and which is able to be repeatedly moved between open and closed positions;
at least one removable rack comprising a grate which is attached to said frame via rack tabs;
a timer;
at least one UV light lamp;
a heating unit;
a control unit;
a user interface which is connected to said timer and said control unit for controlling temperature and timing of a sanitizing and warming period and which comprises a digital time and temperature indicator; and
a drip catch to catch excess moisture;
wherein said frame defines an outer parameter of said inner volume;
wherein said door is hingedly coupled to said frame such that said inner volume is accessible by a user;
wherein said removable rack is suitable to hold at least one towel during said at least one sanitizing and warming period;
wherein said timer is settable to initiate and time said sanitizing and warming period and said hot towel cabinet can be programmed to turn on at a specific time, to turn off at a certain threshold temperature or to turn off at a certain threshold time;
wherein said UV light lamp sanitizes said towels during said sanitizing and warming period;
wherein said heating unit is integral with said hot towel cabinet and operates to provide heat to said inner volume; and
wherein said hot towel cabinet is usable to contain said towels during said sanitizing and warming period such that said towels are sanitized and warmed up for a warm towel treatment and/or service.

19. A method of using a hot towel cabinet to warm up and sanitize towels comprising the steps of:
placing at least one towel in said hot towel cabinet;
programming said hot towel cabinet via a user interface to start and stop warming up and sanitizing said at least one towel at a desired time;
warming up and sanitizing said at least one towel; and
removing said at least one warmed up and sanitized towel from said towel cabinet.
